(19) United States
(12) Patent Application Publication
(10) Pub. No.: US 2010/0171547 A1
(43) Pub. Date: Jul. 8, 2010

(54) PSEUDO BANDGAP VOLTAGE REFERENCE CIRCUIT

(76) Inventors: Emerson S. Fang, Fremont, CA (US); Tin Tin Wee, Fort Collins, CO (US); Sanjeev K. Maheshwari, Fremont, CA (US)

Correspondence Address: MHKKG / GLOBALFOUNDRIES, P.O. Box 398, Austin, TX, 78767-0698, US

(21) Appl. No.: 12/349,810

(22) Filed: Jan. 7, 2009

(51) Int. Cl. G05F 1/10

(52) U.S. Cl. 327/538

(57) ABSTRACT

A pseudo bandgap voltage reference circuit includes a first transistor and a second transistor, each coupled to a supply voltage node. The circuit also includes an amplifier circuit coupled to a gate terminal of each of the first and the second transistors, a current source coupled to the supply voltage node, and a first diode coupled between the current source and a ground reference node. A first input of the amplifier circuit is coupled to a node between the current source and the first diode. In addition, a first terminal of the first transistor is coupled to a second input of the amplifier circuit in a feedback loop. Also, an output reference voltage is developed at an output node coupled to a second terminal of the second transistor. Further, an output current of the current source is independent of a current flowing through the first terminal of the first transistor.

### BACKGROUND OF THE INVENTION

1. Field of the Invention

This invention relates to semiconductor voltage reference circuits and, more particularly, to bandgap reference circuits.

2. Description of the Related Art

Accurate DC voltage references are ubiquitous building blocks in analog circuit design. Many circuit systems, especially data converters, depend on a stable well-defined voltage reference to achieve performance requirements across variations in process technology, supply voltage, and temperature (PVT) during circuit operation. One such voltage reference is known as a bandgap voltage reference. This class of voltage references typically provides a very stable DC voltage across PVT variation. Temperature-independent behavior of the bandgap output voltage is achieved by appropriately summing two voltage characteristics with temperature coefficients of opposite polarity.

As semiconductor processing technology advances and device geometries continue to get smaller, designing a bandgap reference with very small output voltage variation is increasingly challenging, particularly in deep-submicron CMOS technologies, whether in bulk or silicon-on-insulator (SOI) substrates. The impact of random process variability on circuit behavior is only getting worse as integrated circuit (IC) devices scale to smaller physical dimensions. Moreover, the ability to accurately predict variation in circuit performance using Monte Carlo simulations, for example, is increasingly handicapped by limitations in device variation models and limited characterization of device variation. This may be especially true in cutting-edge products with long design cycles, such as microprocessors, where circuits are designed using extrapolative models to enable time-consuming technology development to take place concurrently. As a result, in many cases, representative variation data is not available during the design process.

Further, conventional complimentary metal oxide semiconductor (CMOS) bandgap reference circuits typically produce a reference voltage of 1.2-1.3V using supply voltages of 1.5V and higher. However, this is unacceptable if the voltage reference needs to be generated using supply voltages near 1.2V or lower. Accordingly, it has become commonplace to build what is referred to as fractional sub-supply bandgap reference circuits. One such conventional sub-supply bandgap reference circuit is shown in FIG. 1.

Turning to FIG. 1, a conventional sub-supply bandgap reference circuit is shown. The conventional sub-supply bandgap reference circuit 100 includes an operational amplifier 105, the output of which drives the gates of transistors M1, M2, and M3. The sources of transistors M1, M2, and M3 are coupled to VDD. The drain of transistor M3 is coupled to circuit ground through a resistor R3. A node between R3 and the drain of M3 is the output of the bandgap reference circuit 100 and provides the voltage reference V_{Ref}. As shown, transistors M1 and M2 form a current mirror 150, which in combination with the amplifier 105, causes I1 and I2 to be substantially the same, ideally. The drain of transistor M1 is coupled to the inverting input of amplifier 105, the anode of diode D1, and to one terminal of resistor R2. The other terminal of R2 and the cathode of D1 are coupled to circuit ground. Similarly, the drain of transistor M2 is coupled to the non-inverting input of amplifier 105, to one terminal of resistor R2′ and to one terminal of resistor R1. The other terminal of R1 is coupled to the anode of diode D2, and the cathode of D2 is coupled to circuit ground.

From the circuit of FIG. 1, it can be shown that the output voltage V_{Ref} may be represented by equation (1) such that

$${V}_{REF} = S \times ( \frac{{R}_{3}}{{R}_{1}} Δ {V}_{D} + \frac{{R}_{3}}{{R}_{2}} {V}_{D 1} ) = S \times ( \frac{{R}_{3}}{{R}_{1}} \frac{η {k}_{B} T}{q} ln N + \frac{{R}_{3}}{{R}_{2}} {V}_{D 1} ) \qquad ( 1 )$$

where S=current mirror scaling factor for output current leg

ΔV_{D}=voltage difference between diodes D1 and D2

V_{D1}=voltage across diode D1

η=diode ideality factor, approximately 1

k_{B}=Boltzmann constant=8.617×10⁻⁵ eV/K

q=electronic charge=1.602×10⁻¹⁹ Coulomb

N=number of identical parallel D₁ diodes to form D₂

The near-temperature-independent behavior of the bandgap output voltage is achieved by appropriately choosing a weighted sum of ΔV_{D} (with a voltage characteristic that is proportional to absolute temperature or “PTAT”) and V_{D1} (with a voltage characteristic that is complementary to absolute temperature or “CTAT”) using a ratio of resistances (R₁, R₂, and R₃) such that the PTAT behavior compensates for the CTAT behavior.

The circuit 100 may work well in some semiconductor technologies, however, when implemented in a deep-submicron CMOS technology, the sub-supply bandgap reference circuit 100 of FIG. 1 may be prone to output voltage variation. Reference voltage variation arises from random process variation resulting in:
current mismatch between transistors M₁, M₂, and M₃
input-referred voltage offset in the operational amplifier
error in weighted summing due variation in resistor ratios
η mismatch between diodes D₁ and D₂, resulting in weighted summing error
variation of diode forward voltage V_{D1}

More particularly, in semiconductor technologies such as 65 nm SOI CMOS technology and beyond (e.g., 45 nm, 32 nm, etc.), the current mismatch between transistors M₁, M₂, and M₃ (and more specifically between transistors M₁ and M₂) is of particular concern. Given the significance of diode series resistance, the bias currents through diodes D₁ and D₂ must be relatively small (e.g., in the range of 1 to 10 μA) to maintain matched η's between the diodes. These small bias currents force the gate overdrive, (i.e., V_{GS}-V_{T}, of transistors M₁ and M₂) to be relatively small, thereby making the drain currents I₁ and I₂ of transistors M₁ and M₂ more susceptible to V_{T} variation. The resulting variation in output reference voltage could be unacceptably high in some systems.

### SUMMARY

Various embodiments of a pseudo bandgap voltage reference circuit are disclosed. In one embodiment, a reference voltage circuit includes a first transistor and a second transistor, each coupled to a supply voltage node. The circuit also includes an amplifier circuit coupled to a gate terminal of each of the first and the second transistors, a current source coupled to the supply voltage node, and a first diode coupled between the current source and a ground reference node. A first input of the amplifier circuit is coupled to a node between the current source and the first diode. In addition, a first terminal of the first transistor is coupled to a second input of the amplifier circuit in a feedback loop configuration. Also, an output reference voltage is developed at an output node coupled to a second terminal of the second transistor. Further, an output current of the current source is independent of a current flowing through the first terminal of the first transistor.

### BRIEF DESCRIPTION OF THE DRAWINGS

FIG. 1 is a diagram of a prior art sub-supply bandgap reference circuit.

FIG. 2 is a diagram of one embodiment of a sub-supply pseudo bandgap reference circuit.

FIG. 3 is a block diagram of a system including an integrated circuit including an embodiment of the sub-supply pseudo bandgap reference circuit of FIG. 2.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims. It is noted that the word “may” is used throughout this application in a permissive sense (i.e., having the potential to, being able to), not a mandatory sense (i.e., must).

### DETAILED DESCRIPTION

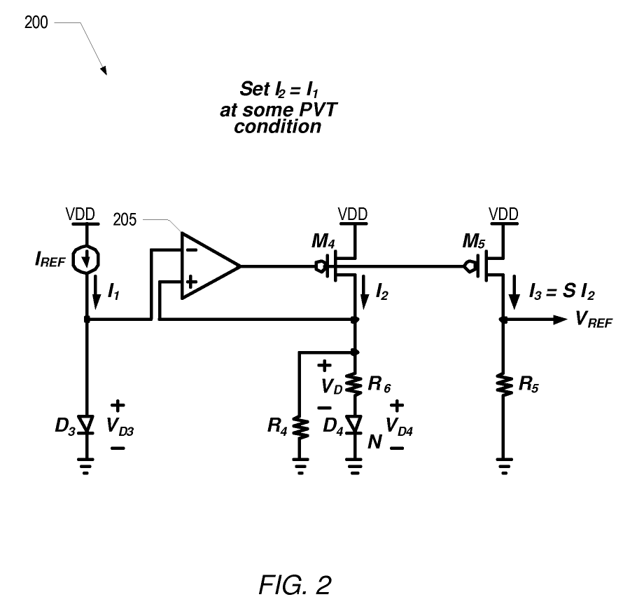

Referring to FIG. 2, a diagram of one embodiment of a sub-supply pseudo bandgap reference circuit is shown. The sub-supply pseudo bandgap reference (PBG) circuit 200, includes a current source designated I_{Ref}, that is coupled between a voltage supply node (VDD) and the anode of diode D3. The cathode of D3 is coupled to a circuit ground node. A node between I_{Ref} and diode D3 is coupled to the inverting input of an operational amplifier 205. The output of the amplifier 205 drives the gates of transistors M4 and M5. The sources of transistors M4 and M5 are coupled to VDD. The drain of transistor M5 is coupled to circuit ground through resistor R5. The node between the drain of M5 and resistor R5 is the output V_{Ref} of the PBG circuit 200. The drain of transistor M4 is coupled to the non-inverting input of amplifier 205 as a feedback loop, and to circuit ground through a resistor R4. The drain of transistor M4 is also coupled to circuit ground through a series connected resistor R6 and diode D4. One terminal of a resistor R6 is coupled to the drain of transistor M4 and the other terminal of R6 is coupled to the anode of diode D4. The cathode of D4 is coupled to circuit ground.

It is noted that in various embodiments, the current reference I_{Ref} may be implemented in a variety of ways. For example, in one embodiment, the current source I_{Ref} may be implemented as a simple resistor, while in other embodiments the current source I_{Ref} may be implemented as a current mirror. It is further noted that the designations “source” and “drain” of the transistors may be interchanged in some implementations as desired.

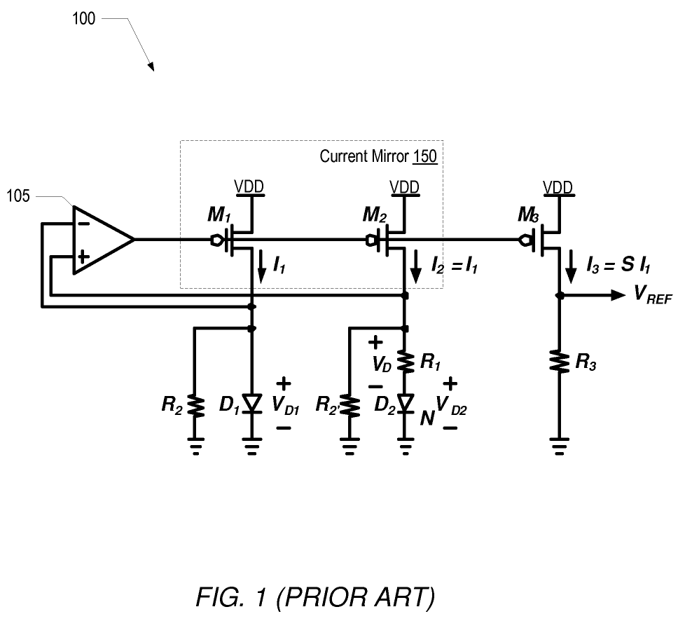

In one embodiment, the PBG circuit 200 may overcome a current mismatch between currents I₁ and I₂ in the sub-supply bandgap reference of FIG. 1 by moving the generation of voltage V_{D1} of FIG. 1 (voltage V_{D3} of FIG. 2) to outside of the operational amplifier feedback loop in FIG. 2. The current through diode D₃ is now established with a new reference current source, I_{REF}. Though the current I₁ may be susceptible to some PVT variation, the voltage V_{D3} should be relatively stable due to the strong logarithmic dependence of diode voltage V_{D3} on current I₁. In one embodiment, the current I_{REF} (I₁ or I_{D3}) is arbitrarily chosen such that I_{D3}=I_{D4} at some nominal PVT condition and then assert that equation (1) approximately holds true. As this current equality can strictly be satisfied at only one PVT condition, there will be some variation in the output voltage V_{REF}. However, as described in greater detail below, a benefit is that the PBG circuit 200 may overcome a mismatch between transistors M₁ and M₂ of the conventional sub-supply bandgap reference of FIG. 1 since transistor M₁ is now completely removed from the operational amplifier feedback loop of FIG. 2.

In the implementation of the conventional sub-supply bandgap reference circuit of FIG. 1, perfect device matching is not typically possible. Thus, introducing some ideality factors, denote the following:

V_{OS}=the amplifier's input referred offset voltage

η₁ and η₂=ideality factors for diodes D₁ and D₂ respectively

I_{D1} and I_{D2}=current in diodes D₁ and D₂ respectively

α=ratio of transistor currents M₁ over M₂ (due to mismatch it is not 1.0)

λ=ratio of diode currents I_{D1} over I_{D2} (due to M1 and M2, and mismatches)

The generated output voltage V_{Ref} may be approximated by equation 2

$${V}_{REF} = α \times S \times \frac{{R}_{3}}{{R}_{2}} \times ( \frac{{R}_{2}}{{R}_{1}} \frac{{η}_{1} {k}_{B} T}{q} ( ln ( λ N ) + {V}_{OS} ) + ( \frac{{η}_{1} - {η}_{2}}{{η}_{2}} ) \frac{{R}_{2}}{{R}_{1}} {V}_{D 2} + {V}_{D 1} ) \qquad ( 2 )$$

Accordingly, since perfect device matching in the actual implementation of the PBG circuit 200 is also not likely, I_{REF} (which is I₁, or I_{D3}) is targeted to be

$${I}_{D 4} ( \approx \frac{{k}_{B} T}{q} \times \frac{1}{{R}_{6}} ) ,$$

and if that is achieved, the reference voltage may be shown to be

$${V}_{REF} = S \times ( \frac{{R}_{3}}{{R}_{1}} \frac{η {k}_{B} T}{q} ln N + \frac{{R}_{3}}{{R}_{2}} {V}_{D 1} ) , \qquad ( 3 a )$$

which is identical to the sub-supply bandgap reference voltage of equation 1. Thus, the nominal reference function provided by the PBG circuit 200 is the substantially the same as a conventional sub-supply bandgap reference circuit 100 of FIG. 1. Substituting the reference designators of FIG. 2 yields

$${V}_{REF} = S \times ( \frac{{R}_{5}}{{R}_{6}} \frac{η {k}_{B} T}{q} ln N + \frac{{R}_{5}}{{R}_{4}} {V}_{D 3} ) . \qquad ( 3 b )$$

However due to process and other factors, there may be deviation from the desired values, and the sub-supply deviation from the desired reference current may be denoted as

$$δ -> {I}_{D 3} = ( 1 + δ ) \times \frac{{k}_{B} T}{q} \times \frac{1}{{R}_{6}} \qquad ( 4 )$$

The deviation in current from ideal in diode D₃ will result a deviation in the current in diode D4 from desired as well, and may be denoted as

$$\begin{matrix}σ -> {I}_{D 4} = ( 1 + σ ) \times \frac{{k}_{B} T}{q} \times \frac{1}{{R}_{6}} , & ( 5 ) \\ where σ = \frac{ln ( \frac{1 + δ}{1 + σ} )}{ln N} & ( 6 )\end{matrix}$$

Then by definition,

$$λ -> \frac{{I}_{D 3}}{{I}_{D 4}} = \frac{( 1 + δ )}{( 1 + σ )} \qquad ( 7 )$$

The output reference voltage for the PBG circuit 200 may be approximated by

$${V}_{REF} = S \times \frac{{R}_{5}}{{R}_{4}} \times ( \frac{{R}_{4}}{{R}_{6}} \frac{{η}_{3} {k}_{B} T}{q} ( ln ( λ N ) + {V}_{OS} ) + ( \frac{{η}_{3} - {η}_{4}}{{η}_{4}} ) \frac{{R}_{4}}{{R}_{6}} {V}_{D 4} + {V}_{D 3} ) \qquad ( 8 )$$

The main difference between equations (2) and (8) is that in equation (2) the α scaling factor is in front, and the factor λ in equation (8) can be significantly larger than that in (2) and still provide smaller deviation in V_{Ref}. The following is an exemplary illustration of a result of this difference. In the conventional circuit of FIG. 1 with no mismatch between transistors M₁ and M₂, Assume

$$S \times \frac{{R}_{3}}{{R}_{2}} \approx 0.5 , and \frac{{R}_{2}}{{R}_{1}} = \frac{\vert {T}_{C - Diode} \vert}{\frac{{k}_{B}}{q} ln N} \approx \frac{1.3 mV \text{/} C . °}{( 0.083 mV \text{/} C . ° ) \times ln 8} = 7.5 .$$

This would yield an output voltage V_{REF}≈600 mV.

Now a 10% device mismatch between transistors M₁ and M₂ of FIG. 1 may result in α=0.9; and equation (2) would yield an output voltage V_{REF}<540 mV. (The reference voltage may actually be less than 540 mV if we account for the fact α=0.9 leads to λ<0.9). Thus, in an IC with more than one reference circuit, if one reference circuit has no mismatch between transistors M1 and M2 and another reference circuit does have a mismatch, then the two identically designed reference circuits located nearby on a single silicon die could have a difference of over 60 mV between output reference voltages.

As mentioned above, there may also be mismatches in the PBG circuit 200. For example, it is not easy to make the reference current I_{REF} exactly equal to

$$\frac{{k}_{B} T}{q} \times \frac{1}{{R}_{6}}$$

in the PBG circuit 200. Assume I_{REF} is off by a factor of 2. If δ=−0.5, then σ=−0.216, and λ≈0.64. The output reference voltage is then off from ideal (e.g., I_{REF}=I_{D4}) by 0.5×7.5×25 mV×ln(0.64)≈−41 mV. Thus, even with a very large I_{REF} deviation from an ideal value, the output voltage change in the PBG circuit 200 is smaller than a corresponding voltage change would be in the circuit of FIG. 1. Furthermore, there significant portion of the deviation of I_{REF} from a desired value is due to manufacturing variation from lot to lot. However, this type of variation may be adjusted using simple calibration methods. In addition, for the PBG circuit 200, the mismatch in reference voltages between two identically designed reference generators located nearby on a single die is much smaller still. For example, assume generator one has λ₁ and generator two has λ₂, then the difference in their output voltages may be given by

$$δ {V}_{REF} = S \times \frac{{R}_{5}}{{R}_{4}} \times ( \frac{{R}_{4}}{{R}_{6}} \frac{{η}_{3} {k}_{B} T}{q} ln ( \frac{{λ}_{1}}{{λ}_{2}} ) ) \qquad ( 9 )$$

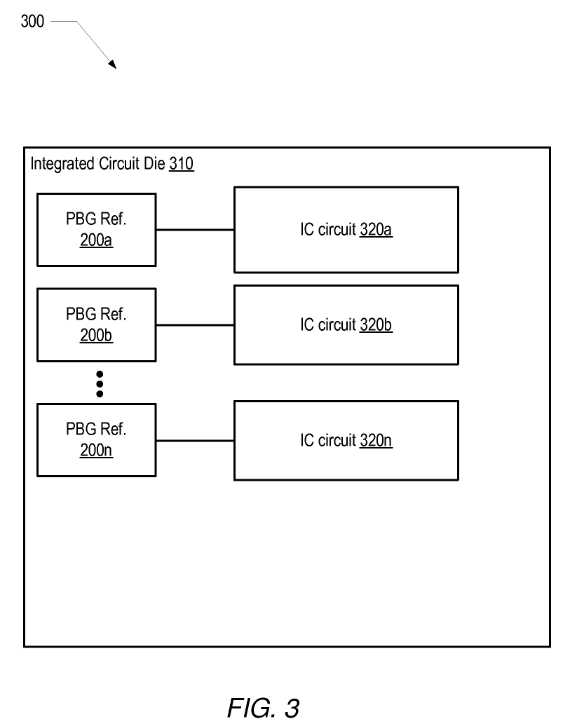

Thus, even with a mismatch in I_{REF} of over 20%, the corresponding reference voltage difference may only be 0.5×7.5×25 mV×ln(0.8)≈−21 mV. This example illustrates that the PBG circuit 200 may provide a superior reference to the conventional sub-supply bandgap reference circuit of FIG. 1, particularly when local on-die variation between multiple proximate identical generators such as those shown in FIG. 3, for example, is a primary factor.

In the PBG circuit 200 of FIG. 2, the start-up circuitry for biasing M₁ and M₂ in FIG. 1 away from a possible trivial solution point where no current flows has been removed. This simplifies the design process circuit validation since start-up circuits may sometimes be unpredictable and can sometimes fail to shut off after establishing correct operating biases. In addition, removing the start-up circuitry may also reduce the silicon area requirement of the die.

It is contemplated that in other embodiments, the PBG circuit 200 may have other specific implementations. For example, in one alternative embodiment, for designs that need improved power supply noise rejection, the AC output resistance of M₅ can be increased with a cascading or common-gate stage. In another alternative embodiment, to achieve a more constant V_{REF} across PVT variation, the output current can be trimmed by implementing M₅ as a number of parallel devices thereby making the current scaling factor S adjustable. The number of parallel devices to activate may be determined for a particular process condition. This is a deterministic form of compensation that can be specified a priori for subsequent circuits after initial silicon characterization, unlike dealing with random device variation which is clearly not deterministic.

Referring to FIG. 3, a block diagram of a system including an integrated circuit die including an embodiment of the sub-supply pseudo bandgap reference circuit of FIG. 2 is shown. The system 300 includes an IC die 310 with a plurality of PBG circuits designated 200a, 200b and 200n, where n may be any number. The IC die also includes a plurality of IC circuits designated 320a, 320b, and 320m, where m may be any number. Each PBG circuit 200 in FIG. 3 is coupled to provide a reference voltage to a respective IC circuit 320. For example, the PBG circuit 200a is coupled to IC circuit 320a, and so on. It is noted that in one embodiment, each of the PBG circuits 200 in FIG. 3 may be identical to the PBG circuit of FIG. 2. It is further noted that although IC die 310 may be any type of integrated circuit, it is contemplated that in one embodiment the IC die 310 may be a microprocessor or processing node having multiple microprocessors manufactured thereon.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A reference voltage circuit comprising:
a first transistor and a second transistor, each coupled to a supply voltage node;
an amplifier circuit coupled to a gate terminal of each of the first and the second transistors;
a current source coupled to the supply voltage node; and
a first diode coupled between the current source and a ground reference node;
wherein a node between the current source and the first diode is coupled to a first input of the amplifier;
wherein a first terminal of the first transistor is coupled to a second input of the amplifier in a feedback loop;
wherein an output reference voltage is developed at an output node coupled to a second terminal of the second transistor; and
wherein an output current of the current source is independent of a current flowing through the first terminal of the first transistor.

2. The reference voltage circuit as recited in claim 1, wherein the first input of the amplifier is an inverting input, and the second input of the amplifier is a non-inverting input.

3. The reference voltage circuit as recited in claim 1, wherein the first terminal of the first transistor is further coupled to the ground reference node through a parallel circuit comprising a first leg and a second leg, wherein the first leg comprises a first resistor and the second leg comprises a second resistor coupled in series with an anode of a second diode.

4. The reference voltage circuit as recited in claim 3, wherein the output node is coupled to the ground reference node through a third resistor.

5. The reference voltage circuit as recited in claim 4, wherein component values of the first resistor and the second resistor are chosen such that the current flowing from the first terminal of the first transmitter is substantially the same as the output current of the current source for a given process, voltage, and temperature combination.

6. The reference voltage circuit as recited in claim 3, wherein a voltage across the first diode is substantially the same as a voltage across the first leg of the parallel circuit.

7. The reference voltage circuit as recited in claim 1, wherein the current source comprises a first resistor.

8. The reference voltage circuit as recited in claim 1, wherein the current source comprises a third transistor and a fourth transistor coupled together to form a current mirror circuit.

9. The reference voltage circuit as recited in claim 1, wherein the output reference voltage is dependent upon the current flowing from the first terminal of the first transmitter.

10. A processor manufactured on an integrated circuit (IC) die, the processor comprising:
one or more circuits; and
one or more reference voltage circuits, each coupled to provide an output reference voltage to a respective one of the one or more circuits, wherein each reference voltage circuit includes:
a first transistor and a second transistor, each coupled to a supply voltage node;
an amplifier circuit coupled to a gate terminal of each of the first and the second transistors;
a current source coupled to the supply voltage node; and
a first diode coupled between the current source and a ground reference node;
wherein a node between the current source and the first diode is coupled to a first input of the amplifier;
wherein a first terminal of the first transistor is coupled to a second input of the amplifier in a feedback loop;
wherein the output reference voltage is developed at an output node coupled to a second terminal of the second transistor;
wherein an output current of the current source is independent of a current flowing through the first terminal of the first transmitter.

11. The processor as recited in claim 10, wherein the first input of the amplifier is an inverting input, and the second input of the amplifier is a non-inverting input.

12. The processor as recited in claim 10, wherein the first terminal of the first transistor is further coupled to the ground reference node through a parallel circuit comprising a first leg and a second leg, wherein the first leg comprises a first resistor and the second leg comprises a second resistor coupled in series with an anode of a second diode.

13. The processor as recited in claim 12, wherein the output node is coupled to the ground reference node through a third resistor.

14. The processor as recited in claim 13, wherein component values of the first resistor and the second resistor are chosen such that the current flowing from the first terminal of the first transmitter is substantially the same as the output current of the current source for a given process, voltage, and temperature combination.

15. The processor as recited in claim 14, wherein a voltage across the first diode is substantially the same as a voltage across the first leg of the parallel circuit.

16. The processor as recited in claim 10, wherein the current source comprises a first resistor.

17. The processor as recited in claim 10, wherein the current source comprises a third transistor and a fourth transistor coupled together to form a current mirror circuit.

18. The processor as recited in claim 10, wherein the output reference voltage is dependent upon the current flowing from the first terminal of the first transmitter.

19. A method of generating a reference voltage, the method comprising:
connecting a first transistor and a second transistor to a supply voltage node of an integrated circuit die;
connecting an amplifier circuit output to a gate terminal of each of the first and the second transistors;
generating a reference current using a current source coupled to the supply voltage node;
connecting a first diode between the current source and a ground reference node;
connecting a node between the current source and the first diode to a first input of the amplifier;
connecting a first terminal of the first transistor to a second input of the amplifier in a feedback loop; and
developing the output reference voltage at an output node coupled to a second terminal of the second transistor;
wherein the reference current of the current source is independent of a current flowing through the first terminal of the first transmitter;

20. The method as recited in claim 19, further comprising connecting the first terminal of the first transistor to the ground reference node through a parallel circuit comprising a first leg and a second leg, wherein the first leg comprises a first resistor and the second leg comprises a second resistor coupled in series with an anode of a second diode.
